(19) United States
(12) Patent Application Publication
(10) Pub. No.: US 2015/0222020 A1
(43) Pub. Date: Aug. 6, 2015

(54) TUNABLE ANTENNA STRUCTURE

(71) Applicant: QUALCOMM Incorporated, San Diego, CA (US)

(72) Inventors: Seng Chin Tai, Sunnyvale, CA (US); Yuan Tao, Shanghai (CN)

(21) Appl. No.: 14/420,962

(22) PCT Filed: Sep. 24, 2012
(86) PCT No.: PCT/US2012/056940

§ 371 Date: Feb. 11, 2015

(51) Int. Cl. H01Q 9/04; H01Q 5/335; H01Q 5/328

(52) U.S. Cl. CPC H01Q 9/0442; H01Q 5/328; H01Q 5/335

(57) ABSTRACT

Example embodiments disclosed herein relate to a tunable antenna structure. A short arm of an antenna structure is coupled to a matching circuit, where the matching circuit is coupled to an input signal. A long arm of the antenna structure is coupled to at least one active tuning element. The short arm is for tuning the antenna structure to a high frequency band and the long arm is for tuning the antenna structure to a low frequency band.

### BACKGROUND

Advances in technology have resulted in many mobile devices supporting multiple radio frequency (RF) technologies such as Wi-Fi, Bluetooth, global positioning system (GPS), long term evolution (LTE), global system for mobile communications (GSM), third generation mobile telecommunications (3G), and the like.

### BRIEF DESCRIPTION OF THE DRAWINGS

The following detailed description references the drawings, wherein:

FIG. 1 is a block diagram of a tunable antenna structure, according to one example;

FIG. 2 is a block diagram of a tunable antenna structure, according to one example;

FIG. 3 is a block diagram of a tunable antenna structure, according to one example;

FIG. 4 is a flowchart of a method for implementing a tunable antenna structure, according to one example;

FIG. 5 is a flowchart of a method for implementing a tunable antenna structure, according to one example; and

FIG. 6 is a block diagram of a machine-readable storage medium encoded with instructions for implementing a tunable antenna, according to one example.

### DETAILED DESCRIPTION

Over the years, mobile devices have shrunk in size as the demand for more compact mobile devices has increased. Accordingly, mobile device manufacturers are challenged to provide mobile devices that operate in multiple RF technologies without sacrificing the compact design of the mobile device. As detailed above, competitive size requirements for mobile devices has put tremendous pressure on antenna designs that support multiple RF frequencies. For example, a mobile device may require one or more antennas to support one or more RF technologies while maintaining a compact design. Moreover, with the development of the LTE network, there is a high demand for mobile devices to provide antennas that operate in the low LTE frequency bands in addition to providing antennas that operate in the more traditional GSM, CDMA, and 3G high frequency bands.

Some existing solutions use a single passive antenna to coyer frequencies from 700 MHz to 2100 MHz (i.e., low and high frequency bands). However, such solutions inherently require large antenna sizes to support the low frequency bands and do not enable a compact mobile device design. Other existing solutions use active capacitive tunable elements to cover the low to high frequency bands. However, these solutions require multiple tuning stales (e.g., 4 tuning states) to cover multiple bandwidths in the low frequency bands (e.g., the LTE frequency bands of 700 MHz, 750 MHz, 850 MHz, and 900 MHz).

Accordingly, examples disclosed herein address these issues by implementing a compact tunable antenna structure including two arms—a long arm and a short arm. The long arm is for tuning to low frequency bands (e.g., 700 MHz, 750 MHz, 850 MHz, and 900 MHz), where the long arm is connected to ground via at least one active tuning element. The active tuning element is one of a switch and a variable capacitor. The short arm is for tuning to high frequency bands (e.g., from 1700 MHz to 2100 MHz) and is coupled to a feed (e.g., a RF input signal) and a matching circuit. Thus, the antenna structure implements two states—a low frequency band state and a high frequency band state. Further, tuning of the long arm to a particular one or more frequency in the low frequency band does not affect tuning of the short arm to the high frequency band. Thus, the long arm and the short arm of the antenna structure may operate independently.

In one example, the long arm is L-shaped and includes a plurality of branches, each branch connected to the ground via a switch and capacitor. In such an example, the antenna structure may be tuned to a particular frequency band (e.g., one of 700 MHz, 750 MHz, 850 MHz, and 900 MHz) by selecting a particular branch (via a corresponding switch) of the plurality of branches. To illustrate, the low frequency band includes four operating frequencies, the long arm may include four branches and each operating frequency may be selected by a corresponding switch.

In another example, the long arm is L-shaped and a shorter end of the L-shape is connected to a variable capacitor, and the variable capacitor is connected to the electrical ground. In this example, the active tuning element is a variable capacitor. Further, to tune the long arm to a particular low frequency band, the capacitance of the variable capacitor is adjusted or varied by applying voltage to terminals of the variable capacitor. Accordingly, by varying the voltage applied to the variable capacitor, capacitance of the variable capacitor is modified to select a particular low frequency band of a plurality of low frequency bands (e.g., 700 MHz, 750 MHz, 850 MHz, and 900 MHz frequency bands).

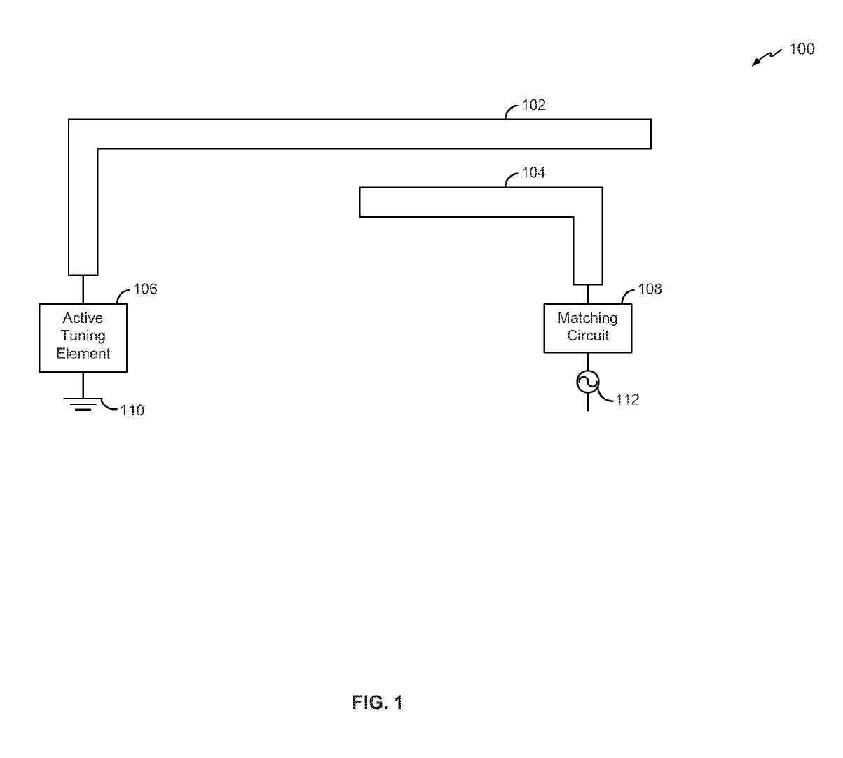

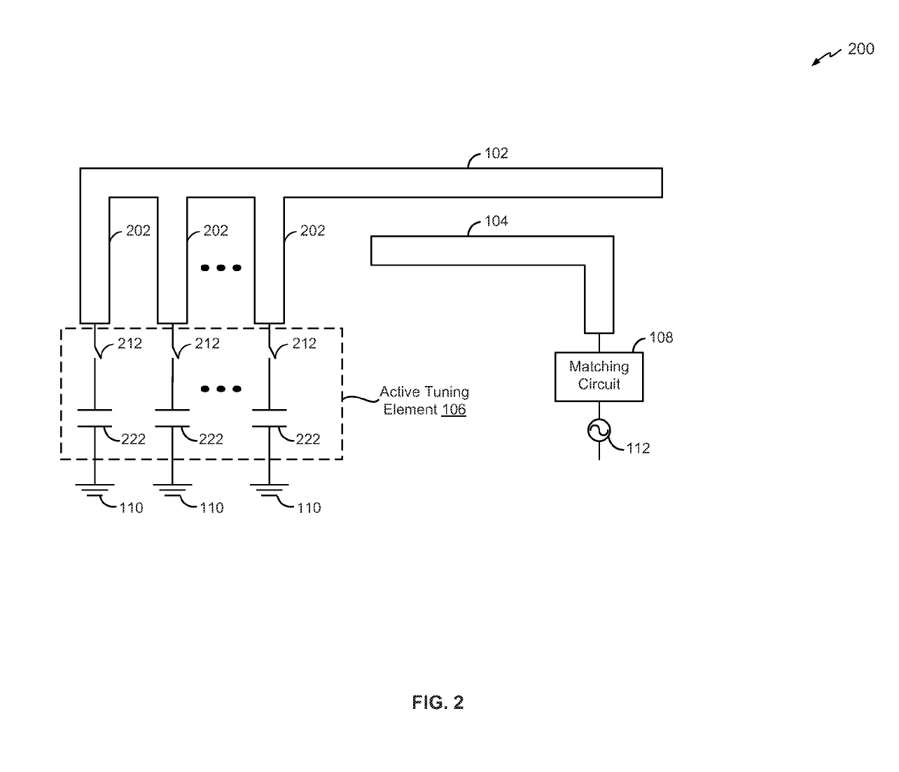

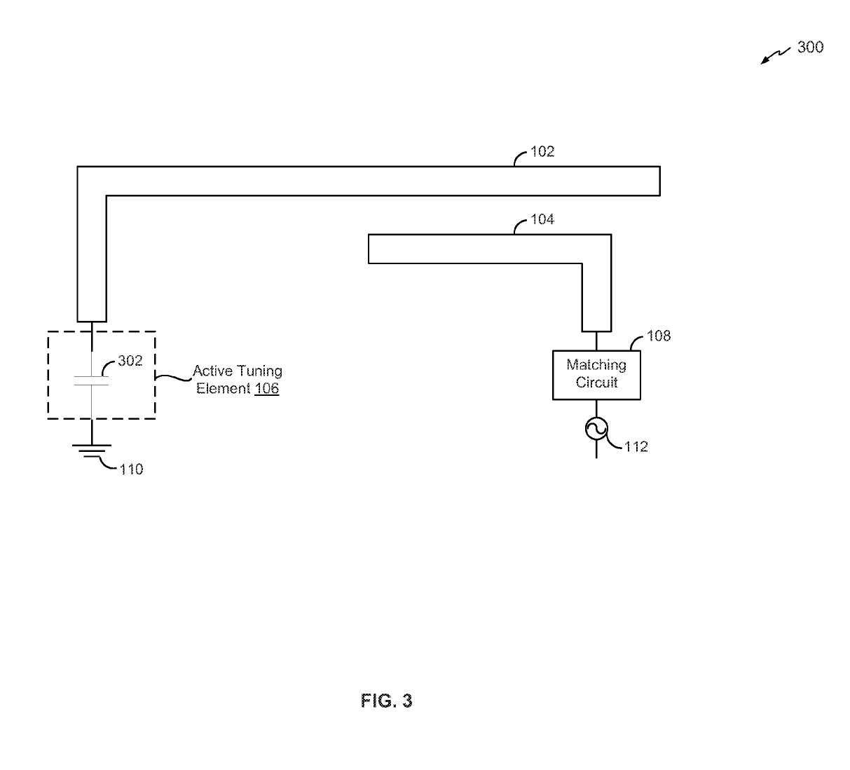

Referring now to the drawings, FIG. 1 is a block diagram of a tunable antenna structure, according to one example. Antenna structure 100 includes, for example, a long arm 102 and a short arm 104. Long arm 102 is coupled to active tuning element 106. Active tuning element 106 is coupled to an electrical ground 110. Long arm 102 may be L-shaped, for example, where a shorter end of the long arm 102 is coupled to the electrically grounded active tuning element 106. In one example, active tuning element 106 is a switch as described in further details with reference to FIG. 2 (e.g., a switch and capacitor combination). In another example, active tuning element 106 is a variable capacitor, as described in further details with reference to FIG. 3. Short arm 104 is coupled to a matching circuit 108. For example, matching circuit 108 may be for matching an impedance of the antenna structure 100 (e.g., matching input impedance to maximize power transfer or minimize reflections in the antenna structure 100). Matching circuit 108 is coupled to an input signal 112. Input signal 112 may include an RF input signal.

The long arm 102 of the antenna structure 100 is responsible for the low frequency bands. Thus, the long arm 102 may be tuned to a particular frequency in the low frequency bands based on the active tuning element 106. For example, the active tuning element 106 is usable to tune the long arm 102 to one or more low frequency bands associated with an LTE network. For example, in a scenario where the active tuning element 106 includes a switch, the active tuning element 106 may be used to tune the long arm 102 by selecting a branch of the long arm 102 to be grounded using the switch, where the selected branch corresponds to a particular low frequency band. In another scenario where the active tuning element includes a variable capacitor, the active tuning element 106 may be used to tune the long arm 102 based on a capacitance value of the variable capacitor, where a particular capacitance value corresponds to a particular low frequency band. The short arm 104 of the antenna structure 100 is responsible for the high frequency bands based on the input signal 112. For example, the input signal 112 may be usable to tune the short arm 104 to one or more high frequency bands (e.g., 1700 MHz to 2100 MHz).

FIG. 2 is a block diagram of a tunable antenna structure, according to one example. In the example of FIG. 2, the active tuning element 106 includes a switch 212 coupled to a capacitor 222. Further, in the example of FIG. 2, the long arm 102 of the antenna structure 200 includes a plurality of branches 202, where each branch 202 is connected to ground 110 via the switch 212 and capacitor 222 combinations. The short arm 104 of the antenna structure 200 is coupled to the matching circuit 108, and the matching circuit 108 is coupled to the input signal 112.

The long arm 202 is scalable to accommodate two or more branches (e.g., 4 branches) depending on how narrow the low frequency bandwidths are. For example, to support 700 MHz, 750 MHz, 850 MHz, and 900 MHz frequency bands, the long arm 102 may include four branches. A particular low frequency band may be selected from the plurality of low frequency bands corresponding to the branches 202 of the long arm 102. For example, the long arm 102 may be tuned to a first frequency band (e.g., the 700 MHz frequency band) by selecting a first branch 202 to the ground (e.g., by closing a first switch 212). Similarly other low frequency bands (e.g., the 750 MHz, 850 MHz, and 900 MHz frequency bands) may be selected via corresponding switches 212. Because an antenna length is inversely proportional to frequency, by closing the switches 212 of the long arm 102, a length of the long arm 102 may be varied by selecting a specific branch 212 to ground, thereby tuning the long arm 102 to specific frequencies.

As explained above, the short arm 104 may be tuned to high frequency bands from 1700 MHz to 2100 MHz, for example. Such high frequency bands may be associated with one or more of GSM, CDMA, and 3G networks. For example, the RF input signal 112 may be used for tuning the short arm 104 to the high frequency bands.

FIG. 3 is a block diagram of a tunable antenna structure, according to one example. In the example of FIG. 3, the active tuning element 106 is a variable capacitor 302. The long arm 102 of the antenna structure 300 is coupled to the variable capacitor 302 and the variable capacitor 302 is coupled to the electrical ground 110. The short arm 104 of the antenna structure 300 is coupled to the matching circuit 108 winch is coupled to the input signal 112.

The variable capacitor 302 may be a voltage controlled tunable capacitor, where voltage is applied to terminals of the variable capacitor 302 to vary the capacitance, thereby tuning the variable capacitor 302 to a plurality of frequencies. In one example, the variable capacitor 302 is a variable capacitance diode where a capacitance value of the variable capacitance diode is varied by applying voltage to the terminals, thereby selecting or tuning the variable capacitance diode to different frequency bands.

The long arm 102 of the antenna structure 300 may be tuned to at least one of the 700 MHz, 750 MHz, 850 MHz, and 900 MHz low frequency bands by varying a capacitance value of the variable capacitor 302. Thus, in the example of FIG. 3, the long arm 102 may not include multiple branches because frequency selection or tuning may be achieved by applying varying voltage values to terminals of tire variable capacitor 302. The short arm 104 may be tuned to the high frequency bands based on the RF input signal 112 applied to the short arm 104.

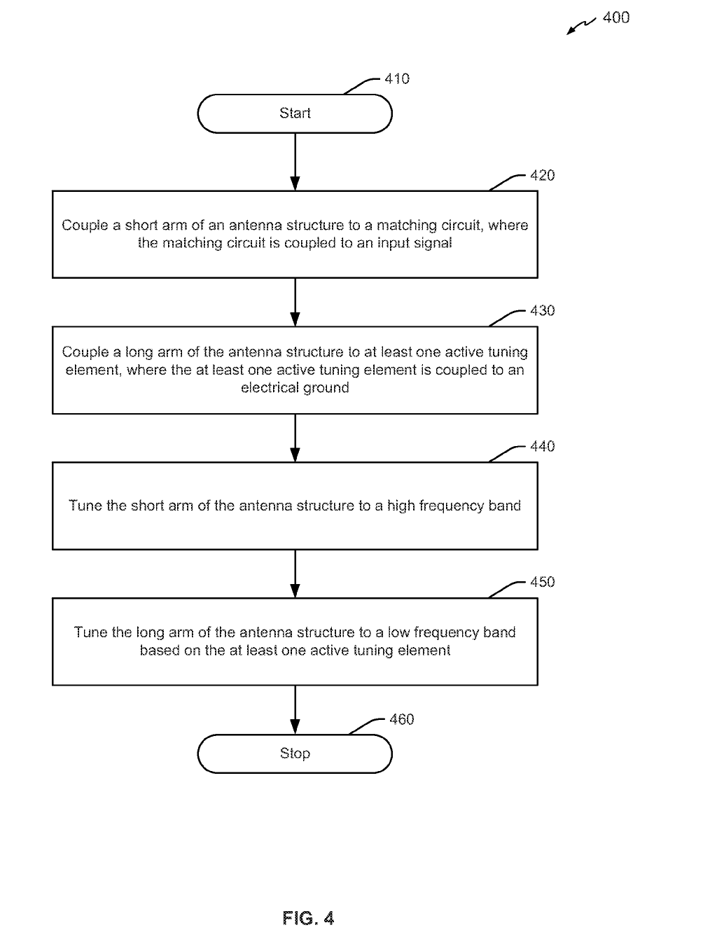

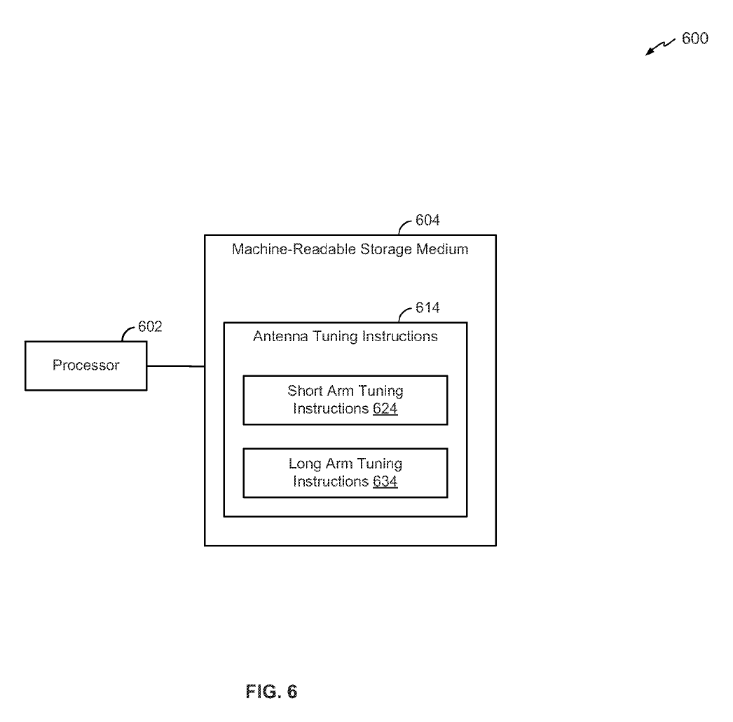

FIG. 4 is a flowchart of a method 400 for implementing a tunable antenna structure, according to one example. Although method 400 is described below with reference to the components of FIGS. 1-3 (i.e., antenna structure 100, 200, and 300, respectively), other suitable components for execution of method 400 will be apparent to those of skill in the art. Additionally, the components for executing the method 400 may be spread among multiple devices. Method 400 may be implemented in tire form of executable instructions stored in a non-transitory machine-readable storage medium, such as machine-readable storage medium 604 of FIG. 6, in the form of electric circuitry, or a combination thereof.

Method 400 may start in block 410 and proceed to block 420, where a short arm of an antenna structure is coupled to a matching circuit, and where the matching circuit is coupled to an input signal. For example, short arm 104 may be coupled to matching circuit 108, and matching circuit 108 may be coupled to the input signal 112, where the input signal 112 is an RF input signal.

The method 400 may proceed to block 430, where a long arm of the antenna structure is coupled to at least one active tuning element, and where the at least one active tuning element is electrically grounded. For example, long arm 102 may be coupled to active tuning element 106 which is coupled to ground 110. In one example, active tuning element 106 includes a switch 212. In another example, active tuning element 106 includes a variable capacitor 302.

Method 400 may proceed to block 440, where the short arm of the antenna structure is tuned to a high frequency band. For example, the short arm 104 may be tuned to a high frequency band associated with at least one of 3G, GSM, and CDMA networks. Alternately, short arm 104 may be tuned to frequency bands in the range of 1700 MHz to 2100 MHz, for example. Short arm 104 may be tuned to a desired high frequency band based on the input signal 112.

The method 400 may proceed to block 450, where the long arm of the antenna structure is tuned to a low frequency band based on the at least one active tuning element. For example, the long arm 102 may be tuned to a low frequency band associated with an LTE network. Alternately, long arm 102 may be tuned to one or more of 700 MHz, 750 MHz, 850 MHz, and 900 MHz. In one example, where the active tuning element 106 is a switch, the long arm 102 may be tuned by selecting a switch corresponding to a particular low frequency band. In another example, where the active tuning element 106 is a variable capacitor, the long arm 102 may be tuned to a particular low frequency band by varying a capacitance value of the variable capacitor. Method 400 may then proceed to block 460, where the method 400 stops.

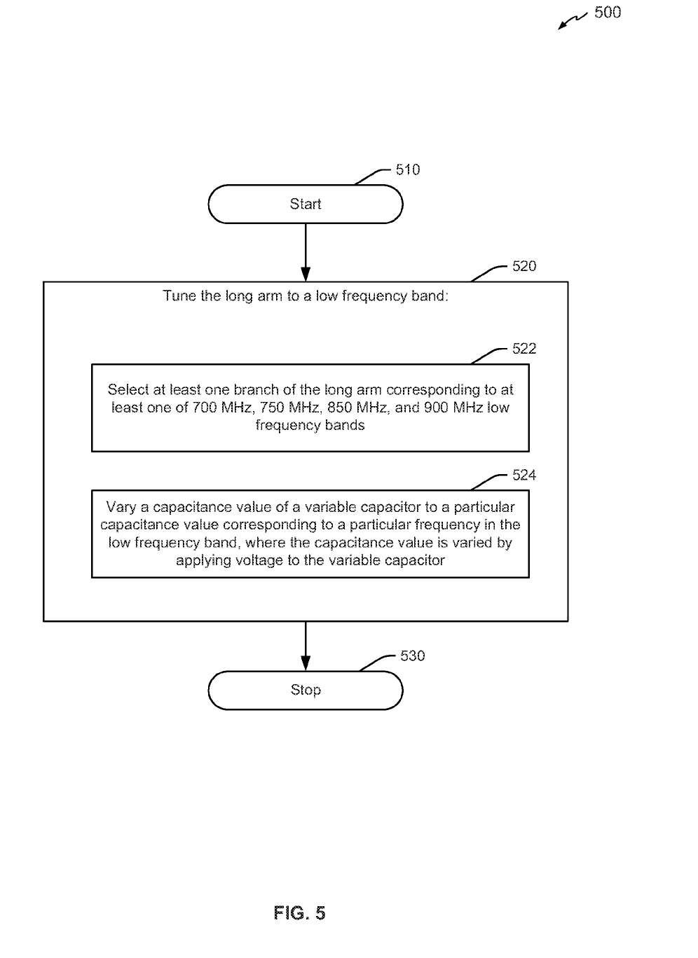

FIG. 5 is a flowchart of a method 500 for implementing a tunable antenna structure, according to one example. Although method 500 is described below with reference to the components of FIGS. 1-3 (i.e., antenna structure 100-300, respectively), other suitable components for execution of method 500 will be apparent to those of skill in the art. Additionally, the components for executing the method 500 may be spread among multiple devices. Method 500 may be implemented in the form of executable instructions stored in a non-transitory machine-readable storage medium, such as machine-readable storage medium 604 of FIG. 6, in the form of electric circuitry, or a combination thereof. The example of FIG. 5 describes tuning of the long arm to low frequency bands.

Method 500 may start in block 510 and proceed to block 520, where the long arm of an antenna structure is tuned to a low frequency band. For example, tuning the long arm 102 may be accomplished by the active toning element 106. In one example, the active tuning element 106 is a switch 212. In another example, the active tuning element 106 is a variable capacitor 302.

The method 500 may include block 522, where at least one branch of the long arm corresponding to at least one of 700 MHz, 750 MHz, 850 MHz, and 900 MHz low frequency bands is selected. For example, the long arm 102 may include a plurality of branches 202, where each branch 202 is coupled to a switch 212. The switch 212 of a particular branch 202 is selected (i.e., switch is closed to ground the branch) to tune the long arm to a particular low frequency band.

The method 500 may include block 524, where a capacitance value of a variable capacitor is varied to a particular capacitance value corresponding to a particular frequency in the low frequency band. The capacitance value may be varied by applying voltage to the variable capacitor. For example, the capacitance value of the variable capacitor 302 may be varied to tune the long arm 102 to different low frequency bands. The method 500 may then proceed to block 530, where the method 500 stops.

FIG. 6 is a block diagram of a machine-readable storage medium encoded with instructions for implementing a tunable antenna, according to one example. FIG. 6 includes, for example, a processor 602 and a machine-readable storage medium 604 including instructions 614, 624, and 634 for implementing a tunable antenna.

Processor 602 may be a microprocessor, a semiconductor-based microprocessor, other hardware devices or processing elements suitable for retrieval and executions of instructions stored in machine-readable storage medium 604, or any combination thereof. Processor 602 may fetch, decode, and execute instructions stored in machine-readable storage medium 604 to implement the functionality described in detail below. As an alternative or in addition to retrieving and executing instructions, processor 602 may include at least one integrated circuit (IC), other control logic, other electronic circuits, or any combination thereof that include a number of electronic components for performing the functionality of instructions 614, 624, and 634 stored in machine-readable storage medium 604. Further, processor 602 may include single or multiple cores in a chip, include multiple cores across multiple devices, or any combination thereof.

Machine-readable storage medium 604 may be any non-transitory electronic, magnetic, optical, or other physical storage device that contains or stores executable instructions. Thus, machine-readable storage medium 604 may be, for example, NVRAM, Random Access Memory (RAM), an Electrically Erasable Programmable Read-Only Memory (EEPROM), a storage drive, a Compact Disc Read Only Memory (CD-ROM), and the like. Further, machine-readable storage medium 604 can be computer-readable as well as non-transitory. As described in detail below, machine-readable storage medium 604 may be encoded with a series of executable instructions for implementing a tunable antenna. Other suitable formats of the executable instructions will be apparent to those of skill in the art.

Machine-readable storage medium 604 may include antenna tuning instructions 614 which may comprise short arm tuning instructions 624 and long arm toning instructions 634. Short arm tuning instructions 624 may be configured to tune a short arm of an antenna structure to a high frequency band. For example, short arm tuning instructions 624 may be configured to tune the short arm 104 to frequency bands from 1700 MHz to 2100 MHz. As another example, short arm tuning instructions 624 may be configured to tune the short arm 104 to frequency bands associated with GSM, 3G, and CDMA networks.

Long arm tuning instructions 634 may be configured to tune a long arm of an antenna structure to a low frequency band. For example, long arm tuning instructions 634 may be configured to tune the long arm 102 to low frequency bands such as 700 MHz, 750 MHz, 850 MHz, and 900 MHz. As another example, long arm tuning instructions 634 may be configured to tune the long arm 102 to frequency bands associated with an LTE network.

What is claimed is:

1. A tunable antenna structure, comprising:
a matching circuit coupled to a radio frequency (RF) input signal;
a short L-shaped arm coupled to the matching circuit, the short arm to tune the antenna to a high frequency band;
at least one active tuning element; and
a long L-shaped arm coupled to the at least one active tuning element, the long arm to tune the antenna to a low frequency band.

2. The antenna structure of claim 1, wherein the low frequency band comprises at least one of 700 MHz, 750 MHz, 850 MHz, and 900 MHz frequency bands, and wherein the high frequency band comprises at feast one of 1800 MHz, 1900 MHz, 2100 MHz, and 2600 MHz frequency bands.

3. The antenna structure of claim 1, wherein the at least one active tuning element comprises at least one of a switch and a variable capacitor.

4. The antenna structure of claim 3, wherein the long arm comprises at least one branch, wherein the at least one branch is coupled to an electrical ground via the switch and a capacitor.

5. The tunable antenna of claim 4, the switch to select the at least one branch of the long arm for tuning the long arm to at least one of 700 MHz, 750 MHz, 850 MHz, and 900 MHz low frequency bands.

6. The tunable antenna of claim 3, wherein the variable capacitor is coupled an electrical ground.

7. The antenna structure of claim 6, wherein the variable capacitor comprises a voltage-controlled tunable capacitor.

8. The tunable antenna structure of claim 6, wherein the variable capacitor comprises a variable capacitance diode, wherein a capacitance value of the variable capacitance diode is modified according to a voltage value applied to the variable capacitance diode to select at least one of 700 MHz, 750 MHz, 850 MHz, and 900 MHz frequency bands.

9. The antenna structure of claim 1, wherein the matching circuit is to match an impedance of the antenna structure.

10. The antenna structure of claim 1, wherein the low frequency band includes a frequency band associated with a long term evolution (LTE) network.

11. The antenna structure of claim 1, wherein the high frequency band includes high frequency bands associated with at least one of a global system for mobile communications (GSM) network, a third generation mobile telecommunications (3G) network, and a long term evolution (LTE) network.

12. A method comprising:
coupling a short arm of an antenna structure to a matching circuit, wherein the matching circuit is coupled to an input signal;
coupling a long arm of the antenna structure to at least one active tuning element, wherein the at least one tuning element is coupled to an electrical ground;
tuning the short arm of the antenna structure to a high frequency band; and
tuning the long arm of the antenna structure to a low frequency band based on the at least one active tuning element.

13. The method of claim 12, wherein the active tuning element comprises at least one of a switch and a variable capacitor.

14. The method of claim 13, wherein the long arm comprises at least one branch coupled to the electrical ground via the switch and a capacitor.

15. The method of claim 14, wherein tuning the long arm to the low frequency band comprises using the switch to select the at least one branch corresponding to at least one of 700 MHz, 750 MHz, 850 MHz, and 900 MHz low frequency bands.

16. The method of claim 13, wherein tuning the long arm to the low frequency band comprises:
varying a capacitance value of the variable capacitor to a particular capacitance value corresponding to a particular frequency in the low frequency band,
wherein the low frequency band includes at least one of 700 MHz, 750 MHz, 850 MHz, and 900 MHz frequency bands.

17. The method of claim 16, wherein varying the capacitance value of the variable capacitor comprises applying voltage to the variable capacitor, wherein the variable capacitor comprises a variable capacitance diode.

18. A non-transitory computer readable medium comprising instructions that, when executed by a processor, cause the processor to:
tune a short arm of an antenna structure to a high frequency band, wherein the short arm is coupled to a matching circuit, and wherein the matching circuit is coupled to an input signal;
tune a long arm of the antenna structure to a low frequency band, wherein the long arm is coupled to at least one active tuning element, and wherein the at least one active tuning element is coupled to an electrical ground.

19. The non-transitory computer readable medium of claim 18, wherein the at least one active tuning element comprises at least one of a switch and a variable capacitor.

20. The non-transitory computer readable medium of claim 19, comprising instructions executable by the processor to:
select at least one branch of a plurality of branches of the long arm via the at least one switch to tune the long arm to the low frequency band; and
vary a capacitance value of the variable capacitor to tune the long arm to the low frequency band,
wherein the low frequency band includes at least one of 700 MHz, 750 MHz, 850 MHz, and 900 MHz frequency bands.
